(19) United States
(12) Patent Application Publication
(10) Pub. No.: US 2017/0027161 A1
(43) Pub. Date: Feb. 2, 2017

(54) Method and Apparatus for Hunting and Surveying Bucks

(71) Applicant: David L. Jones, Houston, TX (US)

(72) Inventor: David L. Jones, Houston, TX (US)

(21) Appl. No.: 15/223,821

(22) Filed: Jul. 29, 2016

Related U.S. Application Data
(60) Provisional application No. 62/199,811, filed on Jul. 31, 2015.

(51) Int. Cl. A01M 31/06; A01M 31/00

(52) U.S. Cl. CPC A01M 31/06; A01M 31/002

(57) ABSTRACT

A portable, artificial scrape tree having a secured game camera is provided for use in buck hunting. A method for hunting is provided consisting of anchoring an artificial scrape tree to the ground at a first location adjacent to a doe's bedding area and primary food sources and a buck's bedding area and food sources. Also provided is a new method for surveying an area of land, consisting of allocating a plurality of artificial scrape trees on the area of land being surveyed, with each artificial scrape tree being outfitted with at least one game camera for recording buck activity near the artificial scrape tree.

### CROSS REFERENCE TO RELATED APPLICATION

This application claims priority to U.S. Provisional Application No. 62/199,811, filed on Jul. 31, 2015, and the contents of that application are incorporated by reference herein.

### BACKGROUND OF THE INVENTION

This invention relates to a method and apparatus for attracting and surveying bucks in a given area.

Deer hunting season generally occurs in the fall, coinciding with the mating season of deer. During the mating season, male deer (or “bucks”) often compete with one another for territory and females (“or does”) with which to mate. During the mating season, or “rut” as it is more commonly called, bucks in a given area are very sensitive to intrusion by other bucks and are disposed to investigate the competition in their area.

During the rut, a buck tends to become very predictable in his mating activities. For example, a buck marks its territory by creating a “scrape,” the resultant geographical area provided by a buck which has pawed out a small circular area in the dirt upon which he urinates. The urine combines with pheromone secretions of the buck to form a mixture having a musky odor indicative of that particular buck's presence. The scrape is usually positioned 4-5 feet below an overhanging branch that the buck rubs with his forehead leaving his scent. A buck also chews on the overhanging branches leaving scent from his saliva. A buck may leave several scrapes in his territory for the purpose of luring receptive does to the area. A doe will find the scrapes and if she is receptive will also urinate in the scrapes. The buck will scent check the scrapes regularly and will trail a receptive doe if his scrape has been anointed by the doe.

Various techniques have been developed over the years for hunters to take advantage of this mating process. For example, hunters often prepare a “mock scrape” to attract a buck, either by finding an existing scrape or by scraping the ground in a manner similar to a buck, and then depositing commercially available scent thereon in an attempt to signal to the buck the presence of a receptive doe. There are several drawbacks to the use of mock scrapes, including determining a proper scent for attracting a buck to the mock scrape, reliably dispensing the appropriate scent in a manner that will actually attract a desired buck, and more fundamentally, properly positioning the mock scrape for success.

Another method used by hunters to aid in hunting bucks is surveying the area using so-called “game cameras” or “trail cameras.” Game cameras are used essentially to spy on wildlife in a hunting area, and allows hunters to see bucks and does in their environment under relaxed conditions. Game cameras provide hunters with a large amount of information about the area, including the number of bucks in the area, the ratio of bucks to does, buck growth rates, and buck movement patterns over time. Numerous game cameras are often placed strategically across an area of land, typically using corn (if legal in that particular state) to attract deer to the cameras. Although there are numerous advantages to using game cameras, there are still many drawbacks to using game cameras, including, but not limited to, the high cost of corn, the significant time necessary to fully survey an area of land, the number of cameras required to adequately survey an area, and the large number of non-buck pictures captured. What is needed is an improved method for surveying bucks in a particular area.

### DETAILED DESCRIPTION OF THE INVENTION

According to a first embodiment of the present invention, an artificial scrape tree for use in buck hunting is provided. Rather than relying on existing trees for creating a mock scrape, the present invention provides an artificial tree base that can be optimally located by a hunter proximate to a doe's bedding areas and primary food sources, and a buck's bedding area and food sources. As such, the apparatus of the present invention provides a pre-selected location for one or more bucks to scrape. In this manner, what is also described herein is an inventive method for attracting bucks to the artificial scrape tree for hunting.

According to a second embodiment of the present invention, a new method for surveying an area of land is provided. According to this method, one or more artificial scrape trees are allocated on the area of land being surveyed, each artificial scrape tree being outfitted with at least one game camera for recording buck activity near the artificial scrape tree.

In order to provide a better understanding of the foregoing, the following non-limiting examples are offered. Although the examples may be directed to specific embodiments, they are not to be viewed as limiting the invention in any specific respect.

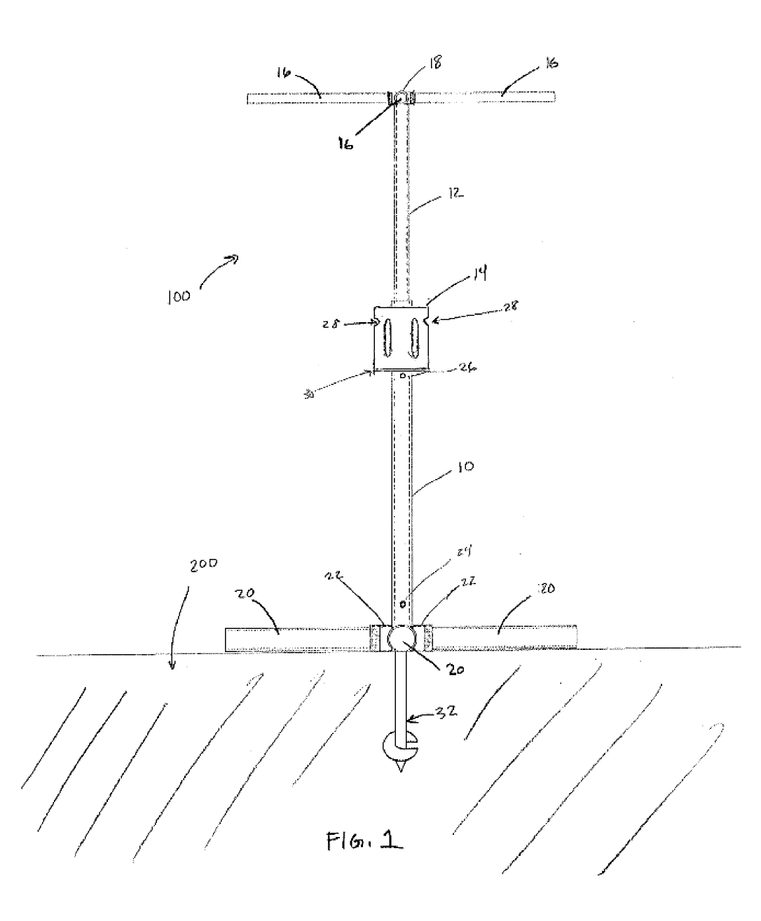

Referring first to FIG. 1, a preferred embodiment of an artificial scrape tree 100 is shown, and generally comprises a lower body 10, an upper body 12, a camera plate 14, upper arms 16, and lower arms 20. The lower body 10 is preferably made from 1″ carbon steel square tubing, although it is envisioned that other materials, shapes, and sizes may be utilized. In this preferred embodiment, the upper body 12 is slightly smaller that lower body 10 such that upper body 12 is collapsible substantially inside lower body 10. Upper body 12 is preferably ¾″ carbon steel square tubing, although it is envisioned that other materials and sizes may be utilized. In operation, lower body 10 and upper body 12 is held in substantially rigid position utilizing a push pin or lock pin (26) or the like at one of several adjustable height locations (holes) located in upper body 12.

In one embodiment of the present invention, preferably four upper arms 16 are attached to upper body 12 using threaded stubs connected to upper body 12. As shown in FIG. 1, upper arms 16 are preferably threaded into a low pressure malleable iron cross fitting 18 welded to upper body 12, but it is also envisioned that fitting 18 may be removably attached by any well-known means. It is also envisioned that upper arms 16 may be attached to upper body 12, either permanently or removably, using other well-known means. Upper arms 16, which may number three or more, are preferably 14 inches long and made from ½″ carbon steel pipe, although it is envisioned that other materials, shapes, and sizes may be utilized.

Upper arms 16 are oriented such that cut branches from nearby trees can be attached to provide a buck with branches/leaves to chew while preparing his scrape. In a preferred embodiment, the cut branches are approximately 5-6 feet in length, and can be attached to upper arms 16 using clips, zip ties, duct tape, or any other well-known means. The tips of the branches should be 4-5 feet off the ground in order to be reachable by the bucks and achieve the benefits of the present invention. Upper body 12 may be adjusted within lower body 10, as described above, in order to obtain this preferred branch height.

As illustrated in FIG. 1, lower arms 20 are preferably attached to lower body 10 using threaded couplings 22 connected to lower body 10. It is also envisioned that lower arms 20 may be attached to lower body 10, either permanently or removably, using other well-known means such as push pins, lock pins, or the like. Lower arms 20, which may number three or more, preferably four, are preferably 14 inches long and made from 1″ carbon steel pipe, although it is envisioned that other materials, shapes, and sizes may be utilized. Lower arms 20 serve the important purpose of stabilizing the overall structure, which must withstand the aggressive activity during use by a buck.

A critical feature of the present invention is the stability of the artificial tree 100 during use by a buck. It is preferred that tree 100 be anchored to the ground 200 using any means well known in the art. Preferred anchoring means 32 include a cork screw arrangement (like you use to tie a dog off in the yard) or a ground anchor arrangement (like you secure a mobile home). It is envisioned that either of these options can be welded to a square block, designed to slide inside the bottom of lower body 10, and be secured to lower body 10 accordingly using, for example, a push pin or lock pin (24). Both preferred anchoring options are preferably 12-14″ long.

Camera plate 14 is located on lower body 10, with the top of camera plate 10 being approximately 36″ from the ground. Camera plate 14 is preferably welded to lower body 10, but may be removably or permanently attached to lower body 10 using well-known means. Camera plate 14 is preferably 5″×6″ and has v-shaped grooves 28 cut in the sides so that a bungee cord or the like can be used to secure the game camera (not shown) to camera plate 14. In this illustrative embodiment, two parallel 3″ long vertical slats are also provided in order to utilize a strap to secure the game camera to the camera plate 14. In this illustrative embodiment, camera plate 14 further provides a small lip 30 for stabilizing and supporting the weight of the game camera. It is envisioned that any game camera can be used in conjunction with the apparatus and methods of the present invention, including, without limitation, the Moultrie M-880 Low Glow Game Camera, Bushnell 8MP Trophy Cam Standard Edition, Primos Truth Cam 35 Camera, Browning BTC 2 Trail Force Recon Camera, and other similar brands and models.

In another embodiment of the present invention, a method for using artificial scrape tree 100 to hunt bucks, including white-tail bucks, is disclosed. Rather than relying on existing trees for creating a mock scrape, a hunter may anchor artificial scrape tree 100 in a pre-selected, optimal location adjacent to a doe's bedding area and primary food sources, and a buck's bedding area and food sources. The hunter would then secure cut branches, approximately 5-6 feet in length, to upper arms 16 using zip ties, for example, with the tips of the branches being 4-5 feet off the ground. Utilizing an attached game camera, a hunter can determine when and what type of buck has created a scrape, and use such information in order to perform the hunt. If the artificial scrape tree 100 is underutilized by bucks, the tree can be un-anchored and moved to a new location. As such, one of ordinary skill in the art will appreciate at least the following advantages of this inventive method:

(1) tree 100 can be placed in any location, even if the area is sparse;

(2) tree 100 attracts primarily bucks, so there are fewer pictures of does; and

(3) tree 100 doubles as the hunter's camera stand.

In yet another embodiment of the present invention, a method for surveying an area of land for deer population is disclosed, utilizing a plurality of artificial trees 100. In a test in Southeast Iowa, eight artificial scrape trees 100 were utilized with cameras to fully survey the buck population on roughly 1200 acres of land in just two weeks. This compares to the same survey being performed using 20 cameras (with corn as an attractant) fixed throughout the acreage over a 4.5 month period. As such, one of ordinary skill in the art will appreciate at least the following advantages of the inventive method:

(1) survey cost is reduced because corn is not used as an attractant;

(2) reduced time (2 weeks vs. 4.5 months) to fully survey the acreage;

(3) required fewer cameras (8 vs. 20), so less capital cost; and

(4) selectively only received pictures of bucks, instead of bucks and does.

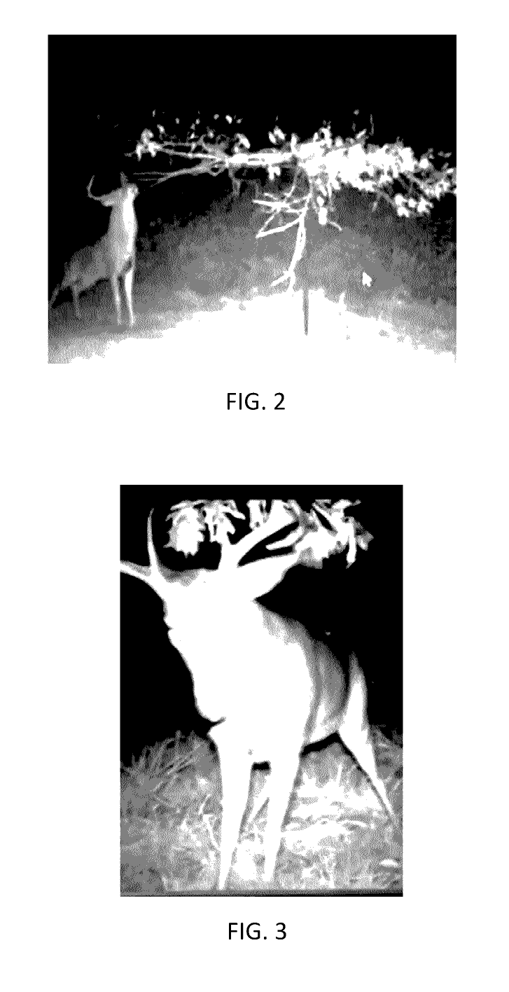

Images taken from a remote camera showing a buck creating a scrape with the artificial scrape tree 100 of the present invention is shown in FIG. 2.

An image showing a buck from the camera installed on artificial scrape tree 100 of the present invention is shown in FIG. 3.

### ADDITIONAL EMBODIMENTS

According to certain teachings of the present invention, a portable artificial tree for luring bucks is provided. The portable artificial tree includes a body having adjustable height, wherein the body comprises an upper body that is collapsible inside of and securable to a lower body at predetermined lengths to adjust the height of the tree. A plurality of upper arms is connected to the top of the body, the arms being attachable to a plurality of cut limbs. A plurality of lower arms is connected to the bottom of the body for stabilizing the tree. A camera plate is attached to the body, which is attachable to a game camera. An anchor is attached to the body for securing the artificial tree to the ground.

Another embodiment of the present invention is a method for hunting a buck using a portable artificial tree. First, the portable artificial tree is anchored to the ground at a first location adjacent to a doe's bedding area and primary food sources and a buck's bedding area and food sources. Cut limbs are attached to the top of the artificial tree. A game camera is secured to the artificial tree. The game camera is then used to observe one or more bucks using the tree for scrape, and a hunter may use this information to hunt the one or more bucks. The portable artificial tree can be relocated to a second location if bucks do not use the tree to create a scrape.

Yet another embodiment of the present invention is a method for surveying an area of land for deer population. The method includes anchoring a plurality of portable artificial trees to the ground throughout the area of land, attaching limbs to the top of the plurality of trees, securing a game camera to each of the plurality of trees, and observing pictures and/or videos of bucks utilizing the plurality of trees for scrape. The ratio of artificial trees used per acre of land is generally between about 1:100 and 1:200, preferably between about 1:150 and 1:175, and most preferably about 1:150. One or more of the portable artificial trees can be moved during the survey to improve the survey.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention.

What is claimed is:

1. A portable artificial tree for luring bucks; comprising:
a body having adjustable height;
a plurality of upper arms connected to the top of the body, wherein the arms are attachable to cut limbs;
a plurality of lower arms connected to the bottom of the body for stabilizing the tree;
a camera plate attached to the body, wherein the camera plate is attachable to a game camera; and
an anchor attached to the body and securing the artificial tree to the ground.

2. The tree of claim 1, wherein the body comprises an upper body and a lower body, wherein the upper body is collapsible inside of and securable to the lower body at predetermined lengths to adjust the height of the tree.

3. A portable artificial tree for luring bucks, comprising:
a body having adjustable height;
a means for attaching cut limbs to the top of the body;
a means for holding a game camera; and
a means for anchoring the tree to the ground.

4. The tree of claim 3, further comprising a means for stabilizing the tree.

5. A method for hunting a buck using a portable artificial tree, comprising:
anchoring the tree to the ground at a first location adjacent to a doe's bedding area and primary food sources and a buck's bedding area and food sources;
attaching cut limbs to the top of the artificial tree;
securing a game camera to the artificial tree;
using the game camera to observe one or more bucks using the tree for scrape; and
hunting said one or more bucks.

6. The method of claim 5, wherein the tree is a portable artificial tree according to claim 1.

7. The method of claim 5, further comprising relocating the tree to a second location if bucks do not use the tree to create a scrape.

8. A method for surveying an area of land for deer population, comprising:
anchoring a plurality of portable artificial trees to the ground throughout the area of land;
attaching limbs to the top of the plurality of trees;
securing a game camera to each of the plurality of trees; and
observing pictures and/or videos of bucks utilizing the plurality of trees for scrape.

9. The method of claim 8, wherein each of the plurality of the trees is a portable artificial tree according to claim 1.

10. The method of claim 8, wherein the ratio of artificial trees used per acre of land is between about 1:100 and 1:200.

11. The method of claim 8, wherein the ratio of artificial trees used per acre of land is between about 1:150 and 1:200.

12. The method of claim 8, wherein the ratio of artificial trees used per acre of land is about 1:150.

13. The method of claim 8, wherein one or more of the plurality of trees can be moved to improve the survey.
